(19) United States
(12) Patent Application Publication
(10) Pub. No.: US 2026/0009427 A1
(43) Pub. Date: Jan. 8, 2026

(54) Torsional Vibration Control Coupling

(71) Applicant: Hasse & Wrede GmbH, Berlin (DE)

(72) Inventors: Michael STEIDL, Berlin (DE); Norbert REINSPERGER, Hoppegarten (DE); Stephan BOHMEYER, Hoppegarten (DE); Sebastian WILLEKE, Hoppegarten (DE)

(21) Appl. No.: 18/992,381

(22) PCT Filed: Jul. 4, 2023
(86) PCT No.: PCT/EP2023/068357

§ 371 Date: Jan. 8, 2025

(30) Foreign Application Priority Data
Jul. 8, 2022 (DE) 10 2022 117 077.2

(51) Int. Cl. F16D 3/12; F16D 3/64; F16F 15/121

(52) U.S. Cl. CPC F16D 3/12; F16D 3/64; F16F 15/121; F16F 2228/063; F16F 2228/12

(57) ABSTRACT

A torsional vibration control coupling having a rotation axis includes a first coupling part as the input side of the coupling, a second coupling part as the output side of the coupling and a damping unit. The damping unit has at least one spring arrangement that is designed as a nonlinear spring arrangement having a degressive load deflection curve.

### BACKGROUND AND SUMMARY

The present invention relates to a torsional-vibration-insulated coupling.

Torsional-vibration-insulated couplings are used, for example, for stationary internal combustion engines.

Such stationary-operated internal combustion engines are also referred to as so-called generating sets which are used in combination with a generator in order to produce electrical energy. Their range of use extends from emergency power supply to the provision of electrical energy for ship drives. These motors are generally operated with diesel fuel or natural gas in this case. Another field of use relates to piston compressors.

In contrast to mobile passenger vehicles or truck drives which are subjected during travel operation both to a variable speed and a frequently changing loading, these applications are characterized by a primarily stationary operation location at a consistent speed and an almost constant load moment.

The current prior art provides to this end primarily torsional-vibration-insulated couplings having a linear spring characteristic curve. The torsion spring rigidity of the torsional vibration insulation is in this instance generally sized with reference to the drive torque which is intended to be transmitted.

In this instance, there are two requirements placed on a torsional-vibration-insulated coupling.

On the one hand, there is a first requirement in the transmission of the static drive torque. The main function of such stationary-operated applications is the provision of an almost constant torque at a fixed speed. This torque acts as a static load on the drive train and must be transmitted by the coupling. The torsional rigidity of the coupling must consequently be accordingly high in order to be able to transmit the static torque.

On the other hand, insulation of the torque fluctuations, that is to say, a wide-ranging vibration insulation, is required.

With regard to the drive train dynamic during the motor operation, the coupling must decouple the components (for example, motor and generator or ship propellor) which are connected to each other by means of the drive train from disruptive influences (for example, fluctuations of the drive or load moment). In order to achieve the most wide-ranging possible vibration insulation of the coupling, consequently, a correspondingly low torsional rigidity of the coupling is required.

From these two requirements, there is a conflicting objective with regard to the optimum torsional rigidity of the coupling. This coupling should, on the one hand, be sufficiently high to transmit the static torque but at the same time be as low as possible in order to insulate from disruptive drive vibrations.

Since the primary objective of the drive train represents the transmission of the static torque, the coupling rigidity is generally selected to be accordingly high. Consequently, a disadvantage of these drive trains is that, in order to damp the undesirable torsion vibrations, additional components are required (for example, torsional vibration dampers) or the components have to be configured for the increased torsion vibrations. This leads, on the one hand, to additional costs and generally also leads to an increased structural space requirement as a result of the increased axial length of the overall train. In addition, a damping effect of these additional components is generally adapted to a limited frequency or speed range.

An object of the invention is therefore to provide a torsional-vibration-insulated coupling which meets both requirements, that is to say, the transmission of the static torque and at the same time the wide-ranging insulation of the drive train and which at the same time no longer has the disadvantages of an increased structural space requirement and limited frequency or speed range or at least significantly reduces them.

This object is achieved by a torsional-vibration-insulated coupling having the features of the independent claim(s).

Accordingly, a torsional-vibration-insulated coupling having a rotation axis comprises a first coupling portion as the input side of the coupling, a second coupling portion as the output side of the coupling and a damping unit. The damping unit has at least one resilient arrangement which is in the form of a non-linear resilient arrangement having a degressive spring characteristic line.

The torsional-vibration-insulated coupling having the damping unit having a non-linear resilient arrangement with a degressive spring characteristic line has the specific advantage that with drive trains of stationary-operated applications a static torque transmission is enabled until the working point is reached.

In contrast to zero stiffness concepts, which achieve a vibration insulation exclusively by means of an insignificantly small rigidity and consequently do not enable a static load transmission, the torsional-vibration-insulated coupling affords the possibility of a static torque transmission in combination with a vibration insulation at the working point. The concept uses to this end the non-linearity of the degressive spring characteristic line of the resilient arrangement of the damping unit.

In one embodiment, the at least one non-linear resilient arrangement has at least one resilient element having a positive spring rigidity k_{PSE} and at least one resilient element having a negative spring rigidity k_{NSE}. This enables an advantageously simple and compact structure.

Another embodiment makes provision for the first coupling portion as the input side of the coupling and the second coupling portion as the output side of the coupling to be coupled via the damping unit to the at least one non-linear resilient arrangement.

With respect to a coupling having a linear spring characteristic line, the torsional-vibration-insulated coupling according to the invention advantageously enables the transmission of the static drive torque and at the same time the wide-ranging vibration insulation during the stationary operation of the application. Consequently, the proposed concept benefits from an improved drive train dynamic without additionally required damping components.

In another embodiment, there is provision for the at least one non-linear resilient arrangement to form an interface in the form of a plate between the at least one resilient arrangement which cooperates with the plate and the first coupling portion of the coupling for bidirectional force transmission and movement transmission. This enables an advantageously simple configuration.

Another embodiment makes provision for the plate to be coupled via a connecting rod to the second coupling portion of the coupling. The connecting rod is an advantageously simple configuration.

When the plate is displaceably guided in a receiving space of the first coupling portion of the coupling in a translation direction u, wherein the translation direction u extends in a tangential direction of the first coupling portion of the coupling, an advantageously compact structure is achieved.

It is advantageous for the at least one resilient element of the at least one resilient arrangement with the negative spring rigidity k_{NSE} to have two resilient elements which are arranged in pairs in an inclined manner with respect to the translation direction u, wherein first ends of the two resilient elements are articulated with spacing from each other to the first coupling portion of the coupling, and the other ends of the two resilient elements in a state joined at a common articulation location are articulated to the plate or to an intermediate plate which cooperates with the plate. In this manner, using simple resilient elements, a structure with a negative rigidity can be achieved.

In this instance, there is provision for the spacing of the first ends of the resilient elements to extend in a direction at right-angles with respect to the translation direction u. An advantage in this instance is a simple structure.

If the intermediate plate is arranged on an end face of the plate in a state not connected to the plate, the torsional-vibration-insulated coupling can thereby enable a torsional vibration insulation advantageously both for positive and for negative static torques T.

For a compact and simple structure, it is advantageous for the first coupling portion of the coupling and the second coupling portion of the coupling to be arranged coaxially with respect to each other.

In one embodiment, the torsional-vibration-insulated coupling is a coupling of a drive train of a stationary-operated application, in particular of a drive train of a stationary-operated internal combustion engine. Consequently, a wide-ranging vibration insulation of the drive train is advantageously enabled.

The present invention sets out a concept with a degressive spring characteristic line for drive trains of stationary-operated applications. The concept fulfills in this instance, in contrast to the prior art, both the requirements of the static torque transmission and the wide-ranging vibration insulation without additional functional units. The use of a conventional coupling in combination with a negative rigidity element results in a non-linear spring characteristic line. The negligibly small spring rigidity at the stationary operating point of the motor enables in this instance a virtually complete vibration insulation of the connected components.

Other advantageous embodiments of the invention can be derived from the dependent claims.

Some exemplary embodiments of the invention will be described below with reference to the appended drawings. The invention is not limited to these exemplary embodiments. In particular, individual features of the following exemplary embodiments can be used not only with these, but also with other exemplary embodiments.

### BRIEF DESCRIPTION OF THE DRAWINGS

FIGS. 1-2 are schematic illustrations of a first exemplary embodiment of a torsional-vibration-insulated coupling according to the invention in a non-loaded state;

FIGS. 3-4 are schematic illustrations of the first exemplary embodiment according to FIGS. 1-2 in a loaded state;

FIGS. 5-6 are schematic illustrations of a second exemplary embodiment of a torsional-vibration-insulated coupling according to the invention in a non-loaded state;

FIGS. 7-8 are schematic illustrations of the second exemplary embodiment according to FIGS. 5-6 in a loaded state;

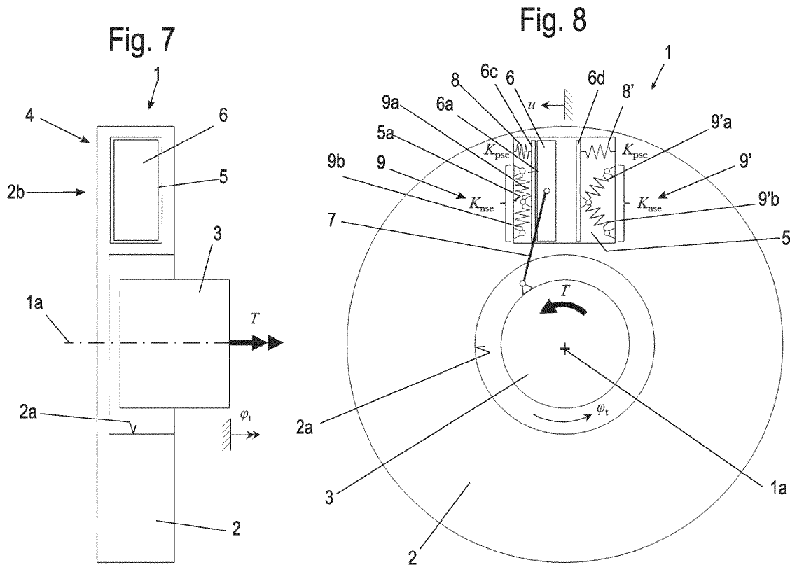

FIGS. 9-10 are schematic illustrations of resilient arrangements; and

FIG. 11 is a graph having spring characteristic lines of a resilient arrangement.

Below, terms such as “outer” or “inner” refer to the respective drawing plane and “axial” and “radial” refer to a rotation axis 1a of a torsional-vibration-insulated coupling 1.

### DETAILED DESCRIPTION OF THE DRAWINGS

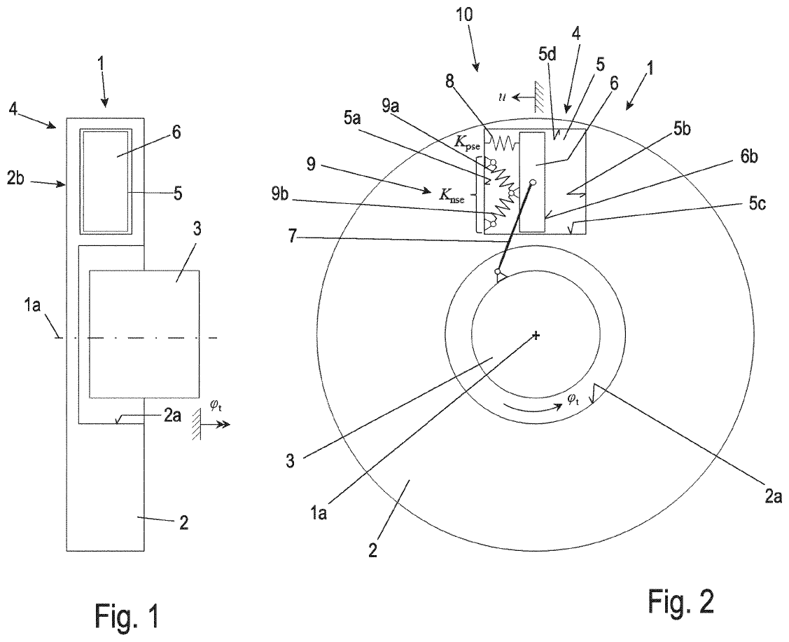

FIG. 1 illustrates a schematic radial sectioned view of a first exemplary embodiment of a torsional-vibration-insulated coupling 1.

FIG. 2 shows a schematic cross section of the torsional-vibration-insulated coupling 1 according to FIG. 1 in a non-loaded state.

The torsional-vibration-insulated coupling 1 comprises a first coupling portion 2 as the input side in the form of a disk having a central recess 2a, a second coupling portion 3 as the output side in the form of a hub or a circular cylinder and a damping unit 4.

The first coupling portion 2 and the second coupling portion 3 are arranged concentrically with respect to the rotation axis 1a of the coupling 1. The second coupling portion 3 is arranged in the recess 2a of the first coupling portion 2.

In an annular region 2b of the first coupling portion 2, a damping unit 4 is arranged in a receiving space 5.

The receiving space 5 is in this instance formed in a parallelepipedal manner in the annular region of the first coupling portion 2 and has in a tangential direction with respect to the rotation axis 1a opposing inner side walls 5a and 5b. In a radial direction with respect to the rotation axis 1a, the receiving space 5 is defined by an inner base wall 5c and an inner covering wall 5d.

The damping unit 4 comprises in this first exemplary embodiment a plate 6 and a resilient arrangement 10.

The plate 6 is displaceably guided in the receiving space 5 by the base wall 5c and the covering wall 5d in a translation direction u.

Between the plate 6 and one inner side wall 5a (in this instance, arranged at the left side of the plate 6), the resilient arrangement 10 connects the plate 6 to one inner side wall 5a of the receiving space 5 of the first coupling portion 2.

The resilient arrangement 10 is in the form of a non-linear resilient arrangement 10 having a resilient element 8 having a positive spring rigidity k_{PSE} and having a resilient element 9 having a negative spring rigidity k_{NSE}. The resilient element 8 having the positive spring rigidity k_{PSE} and the resilient element 9 having the negative spring rigidity k_{NSE} are arranged in a parallel connection.

The resilient element 8 with the positive spring rigidity k_{PSE} is articulated with a first spring end to the inner side wall 5a of the receiving space 5 of the first coupling portion 2 and consequently coupled to the first coupling portion 2.

The other spring end of the resilient element 8 with the positive spring rigidity k_{PSE} is articulated to the plate 6.

The resilient element 9 with the negative spring rigidity k_{NSE} is produced from two resilient elements 9a and 9b which are arranged in pairs and in an inclined manner with respect to the translation direction u. The first ends of the resilient elements 9a, 9b are articulated with spacing from each other to the inner side wall 5a of the receiving space 5 of the first coupling portion 2. This spacing extends in a direction at right-angles with respect to the translation direction u. In this instance, the two resilient elements 9a, 9b are articulated to the plate 6 with the other spring ends thereof in a state joined at a common articulation location.

A connecting rod 7 couples the plate 6 and the second coupling portion 3. In this manner, the first coupling portion 2 as the input side of the coupling 1 and the second coupling portion 3 as the output side of the coupling 1 are coupled in this instance to the resilient arrangement 10 by means of the connecting rod 7 via the damping unit 4.

The plate 6 forms in this manner an interface to the bidirectional force transmission between the first coupling unit 2, the resilient arrangement 10 and the second coupling portion 3, in this instance via the connecting rod 7. In addition, the plate 6 forms a movement redirection of the movement of the connecting rod 7 which transmits the rotational movement of the second coupling portion 3 to the plate 6.

FIG. 2 shows the coupling 1 in a non-loaded state in which a torque T has the value 0 and a torsion angle φₜ between the first coupling portion 2 and the second coupling portion 3 about the rotation axis 1a also has the value 0. In the non-loaded state, all the resilient elements 8a, 9a, 9b of the resilient arrangement 10 are completely untensioned. In this instance, the plate 6 is located at the center of the receiving space 5 in which it has the same spacings in the translation direction u with respect to both inner side walls 5a, 5b of the receiving space 5.

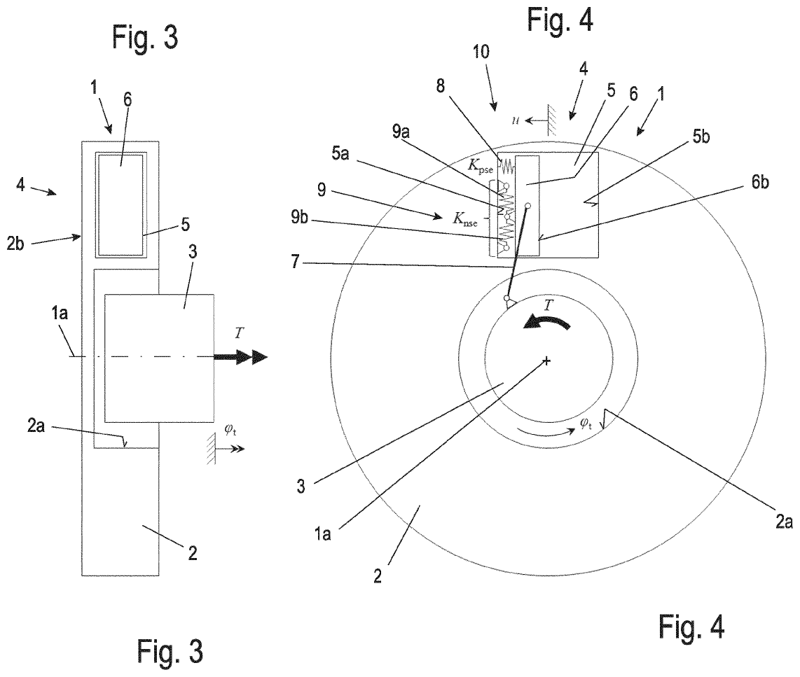

FIG. 3 shows the coupling 1 as in FIG. 1 as a schematic radial section.

FIG. 4 shows a schematic cross section of the torsional-vibration-insulated coupling 1 according to the invention according to FIG. 3 in a non-loaded state.

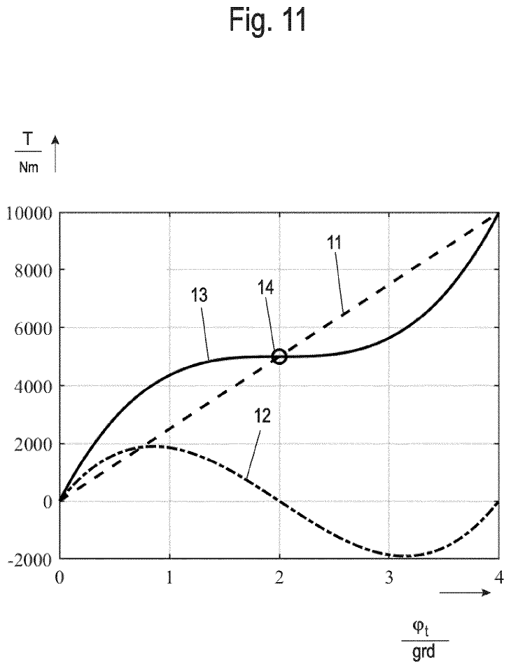

In FIG. 4, the coupling 1 is illustrated by way of example at a working point (WP, see also FIG. 11) during loading by a positive static torque T. In the example shown, the torque T acts in a counter-clockwise direction about the rotation axis 1a. In this instance, the torsion angle φₜ between the first coupling portion 2 and the second coupling portion 3 is not equal to 0.

The plate 6 is displaced with respect to the left inner side wall 5a of the receiving space 5 of the first coupling portion 2, wherein the resilient elements 8, 9a, 9b of the resilient arrangement 10 are compressed.

The resilient arrangement 10 shown enables the transmission of the static torque T regardless of the direction thereof. The torsional vibration insulation by the torsional-vibration-insulated coupling 1 is in this instance exclusively achieved for a static torque T which acts in a positive direction (in this instance, in the counter-clockwise direction about the rotation axis 1a). The term “positive direction” is intended in this instance to be understood to mean that the torque T brings about a displacement of the plate 6 of the damping unit 4 in a positive translation direction u, wherein the plate 6 compresses the resilient elements 8, 9a, 9b against the left inner side wall 5a of the receiving space 5 of the first coupling portion 2.

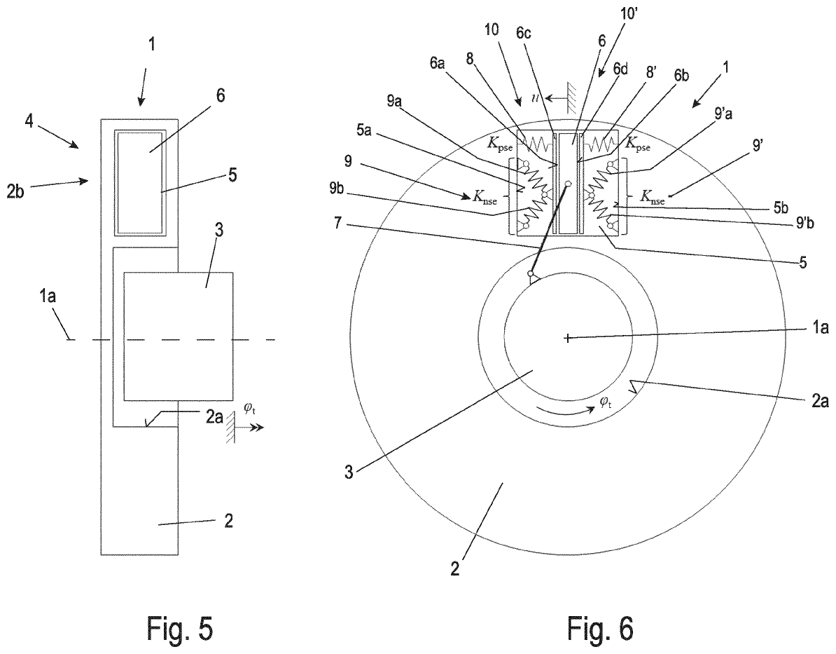

FIG. 5 shows the coupling 1 as in FIG. 1 as a schematic radial section. In FIG. 6, a schematic cross section of a second exemplary embodiment of the torsional-vibration-insulated coupling 1 according to the invention is illustrated in a non-loaded state (T=0).

In contrast to the first exemplary embodiment according to FIG. 2, the damping unit 4 of the coupling 1 has two non-linear resilient arrangements 10 and 10′ which are arranged in a mirror-symmetrical manner with respect to a notional radial center line of the plate 6 in the receiving space 5 of the first coupling portion 2.

In another difference from the first exemplary embodiment, the resilient elements 8, 9a, 9b of the first resilient arrangement 10 and resilient elements 8′, 9′a, 9′b of the second resilient arrangement 10′ which is arranged in a mirror-symmetrical manner with respect to the first resilient arrangement 10 are articulated with the other ends thereof in each case to an intermediate plate 6c, 6d. In this manner, the non-linear damping unit 4 comprises in this instance two parallel connections of in each case one resilient element 8, 8′ with a positive rigidity (k_{PSE}) and one resilient element 9, 9′ with negative rigidity (k_{NSE}).

The first intermediate plate 6c is arranged at a first end face 6a of the plate 6 and the second plate 6d is arranged on a second end face 6b of the plate 6. The intermediate plates 6c, 6d are, however, not connected to the plate 6.

In the loaded states of the second exemplary embodiment of the coupling 1, of which a first loaded state is shown by way of example in FIG. 8 at the working point (WP) during loading by a positive static torque T, the intermediate plate 6d remains in the unloaded position thereof, since it is not connected to the plate 6, wherein the other intermediate plate 6c is pressed by the plate 6 against the resilient arrangement 10 and compresses the resilient elements 8, 9a, 9b against the inner side wall 5a.

In this manner, the second exemplary embodiment of the torsional-vibration-insulated coupling 1 enables a torsional vibration insulation both for positive and for negative static torques T.

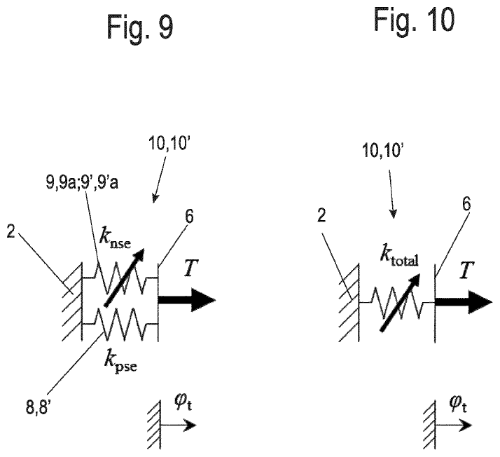

FIGS. 9 and 10 show schematic illustrations of the resilient arrangements 10, 10′.

The concept for torsional vibration insulation of the torsional-vibration-insulated coupling 1 is shown schematically in FIGS. 9 and 10.

The first resilient arrangement 10 comprises the resilient element 8 with a positive spring rigidity k_{PSE} and the resilient element 9 with negative spring rigidity k_{NSE}, comprising the resilient elements 9a and 9b. The resilient arrangement 10 is arranged between the first coupling portion 2 and the plate 6, as already described above.

The parallel connection of the resilient elements 8 (k_{PSE}) and 9a, 9b (k_{NSE}) results in an overall spring rigidity kₜₒₜₐₗ, the rigidity of which results from the addition of the spring characteristic lines 11, 12 of both resilient elements 8 (k_{PSE}) and 9 (k_{NSE}) and is illustrated schematically in FIG. 10. This is explained in greater detail below in connection with FIG. 11.

For the second resilient arrangement 10′ having the resilient elements 8′ (k_{PSE}) and 9′a, 9′b (k_{NSE}), the above description applies in the same manner.

The corresponding spring characteristic lines are shown in FIG. 11 which illustrates a graph with spring characteristic lines of the resilient arrangement 10, 10′.

On the X axis of the graph, the torsion angle φₜ in degrees between the coupling portions 2, 3 is indicated. On the Y axis, the torque T in Nm is indicated.

The graph shows a spring characteristic line 11 of the resilient element 8, 8′ with the positive rigidity k_{PSE}, a spring characteristic line 12 of the resilient element 9, 9′ with the negative rigidity k_{NSE} and a degressive spring characteristic line 13 of the resilient arrangement 10, 10′ with the overall rigidity kₜₒₜₐₗ.

The working point of the coupling 1, at which the torque T=5000 Nm is transmitted and a static coupling torsion having a torsion angle of φₜ=2° is reached, is designated 14. At this working point, the rigidity of the resilient element 8, 8′ with the positive rigidity k_{PSE} is compensated for by the resilient element 9, 9′ with the negative rigidity k_{NSE} so that the resulting degressive spring characteristic line 13 of the coupling 1 at this working point 14 has a negligible overall rigidity (horizontal path of the spring characteristic line 13).

Outside this working point 14, the degressive spring characteristic line 13 of the coupling 1 has a torque T which increases with increasing deflection, that is to say, with an increasing torsion angle φₜ. This non-linearity of the degressive spring characteristic line 13 of the coupling 1 enables, on the one hand, the transmission of a statically acting coupling torque T and, on the other hand, a decoupling of the drive train from fluctuations of the torque T which occur at the stationary working point 14.

### LIST OF REFERENCE NUMERALS

| | |
|---|---|
| Coupling | 1 |
| Rotation axis | 1a |
| First coupling portion | 2 |
| Recess | 2a |
| Annular region | 2b |
| Second coupling portion | 3 |
| Damping unit | 4 |
| Receiving space | 5 |
| Side wall | 5a, 5b |
| Base wall | 5c |
| Covering wall | 5d |
| Plate | 6 |
| End face | 6a, 6b |
| Intermediate plate | 6c, 6d |
| Connecting rod | 7 |
| Resilient (spring) element | 8, 8′ |
| Resilient (spring) element | 9, 9a, 9b; 9′, 9′a, 9′b |
| Resilient (spring) arrangement | 10, 10′ |
| Spring characteristic curve | 11, 12, 13 |
| Working point | 14 |
| Spring rigidity | k |
| Translation direction | u |
| Torque | T |
| Torsion angle | φₜ |

1.-11. (canceled)

12. A torsional-vibration-insulated coupling having a rotation axis, comprising:
a first coupling portion as an input side of the coupling;
a second coupling portion as an output side of the coupling; and
a damping unit,
wherein the damping unit comprises at least one non-linear resilient arrangement having a degressive spring characteristic curve.

13. The torsional-vibration-insulated coupling according to claim 12, wherein
the at least one non-linear resilient arrangement comprises at least one resilient element having a positive spring rigidity k_{PSE} and at least one resilient element having a negative spring rigidity k_{NSE}.

14. The torsional-vibration-insulated coupling according to claim 13, wherein
the first coupling portion as the input side of the coupling and the second coupling portion as the output side of the coupling are coupled via the damping unit to the at least one non-linear resilient arrangement.

15. The torsional-vibration-insulated coupling according to claim 14, wherein
the at least one non-linear resilient arrangement forms an interface in the form of a plate between the at least one non-linear resilient arrangement which cooperates with the plate and the first coupling portion of the coupling for bidirectional force transmission and movement transmission.

16. The torsional-vibration-insulated coupling according to claim 15, wherein
the plate is coupled, via a connecting rod, to the second coupling portion of the coupling.

17. The torsional-vibration-insulated coupling according to claim 15, wherein
the plate is displaceably guided in a receiving space of the first coupling portion of the coupling in a translation direction (u), and
the translation direction (u) extends in a tangential direction of the first coupling portion of the coupling.

18. The torsional-vibration-insulated coupling according to claim 17, wherein
the at least one resilient element having the negative spring rigidity k_{NSE} comprises two resilient elements which are arranged in pairs and in an inclined manner with respect to the translation direction (u),
first ends of the two resilient elements are articulated with spacing from each other to the first coupling portion of the coupling, and
other ends of the two resilient elements, in a state joined at a common articulation location, are articulated to the plate or to an intermediate plate which cooperates with the plate.

19. The torsional-vibration-insulated coupling according to claim 18, wherein
the spacing of the first ends of the resilient elements extends in a direction at right-angles with respect to the translation direction u.

20. The torsional-vibration-insulated coupling according to claim 18, wherein
the intermediate plate is arranged on an end face of the plate in a state not connected to the plate.

21. The torsional-vibration-insulated coupling according to claim 12, wherein
the first coupling portion of the coupling and the second coupling portion of the coupling are arranged coaxially with respect to each other.

22. The torsional-vibration-insulated coupling according to claim 12, wherein
the coupling is a coupling of a drive train of a stationary-operated application.

23. The torsional-vibration-insulated coupling according to claim 22, wherein
the stationary-operated application is a stationary-operated internal combustion engine.
